(19) United States
(12) Patent Application Publication
(10) Pub. No.: US 2003/0116174 A1
(43) Pub. Date: Jun. 26, 2003

(54) Semiconductor wafer cleaning apparatus and cleaning method using the same

(76) Inventors: Jin-goo Park, Ansan-city (KR); Dae-hong Eom, Ansan-city (KR); Jae-hwa Lee, Ansan-city (KR); Neung-goo Yoon, Pyongtaek-city (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/023,940

(22) Filed: Dec. 21, 2001

(51) Int. Cl. B08B 3/12

(52) U.S. Cl. 134/1.3; 134/36; 134/902; 134/111; 134/108; 134/186; 134/99.1; 134/102.1

(57) ABSTRACT

A semiconductor cleaning apparatus and a method of cleaning a wafer surface using the semiconductor cleaning apparatus are provided. In the semiconductor cleaning apparatus, wastewater is easily treated, the consumption of chemical usage is considerably reduced, and a contaminant removal efficiency on the wafer surface is maximized even at a room temperature or a low temperature by using a mixed chemical solution composed of an aqueous ammonium hydroxide and ozone as a cleaning solution in cleaning the wafer surface. In the method of cleaning the wafer surface, a cleaning solution is formed in a mixing tank by adding ozone to aqueous ammonium hydroxide. The cleaning solution is supplied into a cleaning bath through a filter for removing ozone bubble. Megasonic power is applied to the cleaning solution in the cleaning bath using a megasonic transducer. A wafer dipped in the cleaning solution which is at a room temperature to remove the contaminants on wafer surface.

### BACKGROUND OF THE INVENTION

1. Field of the Invention

The present invention relates to a semiconductor cleaning apparatus using a mixed chemical solution of an aqueous ammonium hydroxide (deionized water containing ammonia (NH₄OH)) and ozone (O₃) as a cleaning solution and a wafer cleaning method using the same.

2. Description of the Related Art

The importance of new wafer cleaning technology increases as semiconductor industry requires sub-micron processes and the gate oxide thickness is very thinner in Ultra Large Scale Integrated (ULSI) technology. ULSI technology requires more stringent and reliable means to control the surface smoothness and to remove the contaminants. As a result, in order to reduce process failures occurring in the manufacture of semiconductor devices, a wafer cleaning process including many processes, (e.g., an oxidation process, a diffusion process, a photolithographic process, a cleaning process performed for removing contaminants on a wafer surface before and after an etching process) is necessarily required whenever each unit process is completed.

The representative cleaning process widely used in semiconductor wafer cleaning includes a cleaning process using SC-1 and a cleaning process using a diluted SC-1 to which megasonic power is applied. The SC-1 solution was based on the mixture of ammonium hydroxide (NH₄OH), hydrogen peroxide (H₂O₂) and DI water in a volume ratio of 1:1:5 at 70˜85° C. In SC-1 solution, hydrogen peroxide (H₂O₂) passivates the wafer surface and decomposes the organic contaminants on the wafer surface and ammonium hydroxide (NH₄OH) slightly etches wafer surfaces simultaneously. As a result, contaminants were removed on the Si surface, and contaminant re-contamination was prevented by electrical repulsion between the surface and particle occurred by OH⁻radicals obtained from NH₄OH. Because the SC-1 cleaning was performed at a high temperature, the decomposition of H₂O₂ and evaporation of NH₄OH were accelerated. To avoid the microroughness of surfaces, SC-1 solution was suggested to have a low concentration of ammonium hydroxide and the lower temperature process.

The diluted SC-1 cleaning process, to which megasonic power is applied, has been developed to improve the cleaning efficiency and surface micro-roughness at a temperature of less than 45° C. The concentration of ammonium hydroxide is diluted to reduce roughness of the wafer surface and megasonic power is applied to remove the contaminants effectively. The diluted SC-1 cleaning process uses diluted ammonium hydroxide, and thus reduces the amount of a chemical solution used compared to the SC-1 cleaning process. Also, the temperature required for the diluted SC-1 cleaning process is adjusted to about 45° C., and thus the life of the cleaning solution can be more prolonged than at a high temperature.

A high efficiency in removing contaminants can be obtained using the SC-1 and diluted SC-1 conjunction with megasonic power. However, there are a few problems in cleaning, as described below.

First, since a cleaning solution contains hydrogen peroxide, which is an oxidizer, a dehydrogenation peroxide process is necessarily performed in wastewater treatment after a cleaning process is completed. Thus, the cleaning process is complicated and difficult, and the cost for wastewater treatment increases.

Second, since the SC-1 and the diluted SC-1 cleaning processes are performed at a high temperature, the evaporation of ammonium hydroxide and the decomposition of hydrogen peroxide accelerate. Thus, the concentration of a cleaning solution is diluted with water generated as ammonium hydroxide evaporates and the hydrogen peroxide decomposes. As a result, a cleaning efficiency and the lifetime of the cleaning solution decrease. Also, the consumption of chemical usage for cleaning process increases, and thus the cost of a chemical solution increases.

Third, since cleaning processes are performed at a high temperature, an extra thermostat such as a heater or a temperature sensor is required in a cleaning apparatus. Thus, the cleaning apparatus becomes large-sized and complicated.

### SUMMARY OF THE INVENTION

To solve the above-described problems, it is a first object of the present invention to provide a semiconductor cleaning apparatus in which wastewater is easily treated, the consumption of chemical usage is considerably reduced, and contaminants removal efficiencies on wafer surface are maximized even at a room temperature or a low temperature by using an ammonium hydroxide and ozone chemistry.

It is a second object of the present invention to provide a wafer cleaning method using the semiconductor cleaning apparatus and the cleaning solution.

Accordingly, to achieve the first object, there is provided a semiconductor cleaning apparatus including a cleaning bath, a megasonic transducer, an ozone concentration analyzer, pH and Eh meters, an ammonium hydroxide addition injection port, a mixing tank, a first filter, a supply pipe, an ammonium hydroxide tank, an ozone generator, a circulation pump, a chiller, a second filter, and a wastewater discharging pipe. The cleaning bath is filled with a cleaning solution composed of ammonium hydroxide, deionized water and ozone. The uniform megasonic energy form megasonic transducer is directly transmitted to parallel wafer surfaces using water medium. The ozone concentration analyzer measures the concentration of ozone in the cleaning solution directly or indirectly. pH and Eh meters measure the pH and Eh of the cleaning solution. The ammonium hydroxide addition injection port additionally supplies ammonium hydroxide into the cleaning bath if the concentration of ammonium hydroxide in the cleaning solution decreases to less than a predetermined amount. The mixing tank mixes ammonium hydroxide, deionized water and ozone in a predetermined volume ratio. The first filter removes ozone bubble components in the cleaning solution supplied from the mixing tank. The first filter plays a degasifying role to remove the ozone bubbles in the cleaning solution. The supply pipe supplies the cleaning solution into the cleaning bath through the first filter. The ammonium hydroxide tank supplies ammonium hydroxide into the mixing tank. The ozone generator is connected to the mixing tank and the cleaning bath and supplies ozone into the mixing tank early on a cleaning process and supplies ozone into the cleaning bath after the supply of the cleaning solution into the cleaning bath is exhausted. The circulation pump circulates the cleaning solution in the cleaning bath through the circulation pump. The chiller is filled with DI water or alcohol and lowers the temperature of cleaning solution circulated through circulation pipe. The second filter removes particle components of the cleaning solution supplied through the circulation pipe. The wastewater discharging pipe discharges the almost exhausted cleaning solution.

Here, the chiller is not operated at a room temperature process and is operated if a low temperature process is necessary.

To achieve the second object, there is provided a method of cleaning a semiconductor substrate. In the method, a cleaning solution is formed by adding ozone to aqueous ammonium hydroxide, which is composed of ammonium hydroxide and deionized water in the volume ratio of 0.001-0.01:5. The cleaning solution is supplied into a cleaning bath through a filter for removing ozone bubble. Megasonic power is applied to the cleaning solution in the cleaning bath using a megasonic transducer. A wafer is dipped in the cleaning solution which is at a room temperature to remove contaminants on the wafer surface.

To achieve the second object, there is provided a wafer cleaning method. In the method, a cleaning solution is formed by adding ozone to aqueous ammonium hydroxide, which is composed of ammonium hydroxide and deionized water in the volume ratio of 0.001-0.01:5. The cleaning solution is supplied into a cleaning bath through a filter for removing ozone bubble. The cleaning solution in the cleaning bath circulates through a circulation pipe and then the cleaning solution is supplied into the cleaning bath again along the circulation pipe through a chiller. Megasonic power is applied to the cleaning solution in the cleaning bath using a megasonic transducer. A wafer is dipped in the cleaning solution which is at a low temperature of 10-15° C. to remove contaminants on the wafer surface.

If the wafer surface is cleaned using the cleaning solution, ozone forming the cleaning solution has a larger oxidizing power than hydrogen peroxide and does not form harmful by-products when it decomposes in the cleaning solution. Thus, an efficiency of removing contaminants on the wafer surface is maximized and it is easy to treat the wastewater. Also, a conventional cleaning process is performed at a temperature of 75-95° C., but in the present invention, the cleaning process proceeds at a room or low temperature. Thus, an extra thermostat such as a heater or a temperature sensor is not required in designing the cleaning apparatus. As a result, the cleaning apparatus is downsized and lightweight, and the consumption of chemical usage is considerably reduced.

### BRIEF DESCRIPTION OF THE DRAWINGS

The above objects and advantages of the present invention will become more apparent by describing in detail a preferred embodiment thereof with reference to the attached drawings in which:

FIG. 1 is a schematic diagram of the structure of a semiconductor cleaning apparatus according to the present invention.

### DETAILED DESCRIPTION OF THE INVENTION

Hereinafter, a preferred embodiment of the present invention will be described in detail with reference to the attached drawing.

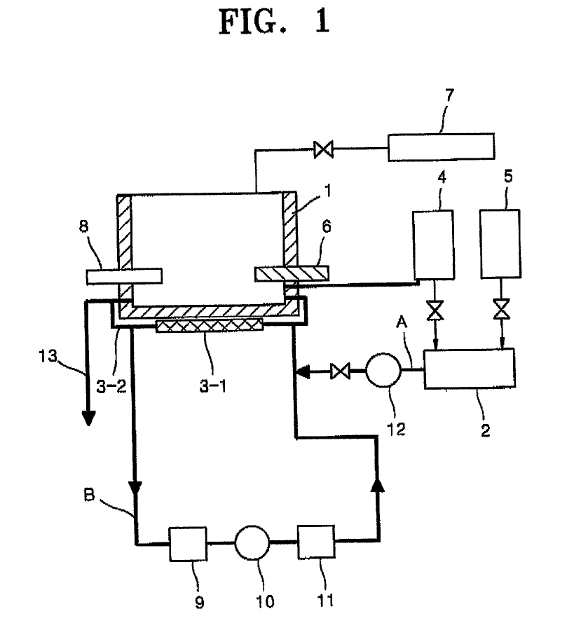

FIG. 1 shows a schematic diagram of a semiconductor cleaning apparatus according to the present invention. Referring to FIG. 1, the basic structure of the semiconductor cleaning apparatus will be described in detail.

A cleaning bath 1 contains a cleaning solution composed of ammonium hydroxide, deionized water and ozone. A megasonic transducer 3-1 is placed underneath the cleaning bath 1. The megasonic transducer 3-1 applies uniform megasonic power to the cleaning bath 1 using water contained in a megasonic bath 3-2 as a medium. An ozone concentration analyzer 6, which measures the concentration of ozone in the cleaning solution, is attached to the lower portion of one sidewall of the cleaning bath 1 and a circulation pipe. pH and Eh meters 8, which measure the pH and Eh of the cleaning solution, are attached to the lower portion of the other sidewall of the cleaning bath 1.

Here, the pH meter provides information on the estimation of the concentration of ammonium hydroxide in the cleaning solution. In general, it is known that if the concentration of ammonium hydroxide is large, the pH is in the high alkaline range. Also, the cleaning and etching efficiencies are dependent on pH and Eh values of solution. Thus, if the pH is too high, the etching efficiency of the wafer surface is increased due to the ammonium hydroxide. As a result, the wafer surface becomes rougher. If the pH is too low, the etching efficiency of the wafer surface is reduced due to the ammonium hydroxide. As a result, contaminant removal efficiency is reduced. Thus, if the pH meter measures the state of the cleaning solution and adjusts the time for the addition of ammonium hydroxide properly, then the above-described phenomena can be prevented. The Eh meter provides information on the estimation of the oxidizing power of the cleaning solution. Thus, the oxidation degree of the wafer surface is estimated. As a result, the amount of ammonium hydroxide and ozone in the cleaning solution can be adjusted.

An ammonium hydroxide addition injection port 7 is connected to the upper portion of the cleaning bath 1. The ammonium hydroxide addition injection port 7 additionally supplies ammonium hydroxide into the cleaning bath 1 when the concentration of ammonium hydroxide in the cleaning solution decreases to less than a predetermined amount. An ammonium hydroxide tank 4, a deionized water supply (not shown), an ozone generator 5 and a mixing tank 2 are disposed beside one side of the cleaning bath 1. The mixing tank 2 mixes ammonium hydroxide, deionized water and ozone, which are supplied through the ammonium hydroxide tank 4, the deionized water supply and the ozone generator 5, in a predetermined volume ratio. A first filter 12 for removing ozone bubble components in the cleaning solution is connected to the mixing tank 2. A supply pipe A for supplying the cleaning solution into the cleaning bath 1 is connected between the first filter 12 and the cleaning bath 1.

The ozone generator 4 is connected to the cleaning bath 1 besides the mixing tank 2. Thus, in the early cleaning process, ozone is supplied only to the mixing tank 2. However, after the supply of the cleaning solution into the cleaning bath 1 is completed, the supply of ozone into the mixture tank 2 stops and ozone is supplied only into the cleaning bath 1. As described above, the semiconductor cleaning apparatus is designed to maximize the contaminant removal efficiency on the semiconductor wafer surface by complementing the amount of ozone consumed during the cleaning process to uniformly maintain the concentration of ozone in the cleaning solution.

A circulation pump 10, which circulates the cleaning solution in the cleaning bath 1 through a circulation pipe B, is connected under the cleaning bath 1. A chiller 9, which lowers the temperature of the cleaning solution flowing through the circulation pipe B, is connected to one side of the circulation pump 10. A second filter 11, which removes particles in the cleaning solution flowing through the circulation pipe B, is connected to the other side of the circulation pump 10. A wastewater discharging pipe 13 for discharging the almost exhausted cleaning solution is connected to the lower portion of the other sidewall of the cleaning bath 1.

Here, the chiller 9 stops driving if the cleaning process is performed at a room temperature and drives only if the cleaning process is performed at a low temperature. In other words, the chiller 9 passes the cleaning solution flowing through the circulation pipe B through a cooling pipe.

Accordingly, using the semiconductor cleaning apparatus having the above-described structure, the wafer surface is cleaned as follows.

First, a case where a cleaning process is performed at a room temperature will be described.

(A) A cleaning solution is formed by adding ozone to aqueous ammonium hydroxide, which is composed of ammonium hydroxide and deionized water in the volume ratio of 0.001-0.01:5. Here, the cleaning solution is formed in the mixing tank 2.

(B) The cleaning solution is supplied into the cleaning bath 1 through the first filter 12. Here, the first filter 12 serves to remove ozone bubble components in the cleaning solution.

(C) The megasonic trasnsducer 3-1 applies megasonic power to the cleaning solution in the cleaning bath 1.

(D) The wafer surface is dipped in the cleaning solution which is at a room temperature to remove contaminants on the wafer surface.

Next, a case where a cleaning process is performed at a low temperature of 10-15° C. will be described.

(A) A cleaning solution is formed by adding ozone to aqueous ammonium hydroxide, which is composed of ammonium hydroxide and deionized water in the volume ratio of 0.001-0.01:5. In this case, the cleaning solution is also formed in the mixing tank 2.

(B) The cleaning solution is supplied into the cleaning bath 1 through the first filter 12.

(C) The cleaning solution supplied into the cleaning bath 1 is circulated through the circulation pipe B and then is supplied into the cleaning bath 1 again along the circulation pipe B through the chiller 9. The cleaning solution is repeatedly circulated until the temperature of the cleaning solution supplied into the cleaning bath 1 drops to a low temperature of 10-15° C.

(D) The megasonic transducer 3-1applies megasonic power to the cleaning solution in the cleaning bath 1.

(E) The wafer surface is dipped in the cleaning solution which is at a room temperature to remove contaminants on the wafer surface.

In other words, it is noticed that the two cleaning processes are performed by the same method except that the temperature of the cleaning solution supplied through the circulation pipe B drops to a low temperature due to the chiller 9

If a cleaning process is performed according to the above-described methods using the semiconductor cleaning apparatus shown in FIG. 1, the following advantages result.

First, instead of hydrogen peroxide, ozone, which has a larger oxidizing power than hydrogen peroxide and does not form harmful by-products when ozone is decomposed in a cleaning solution, is used. Thus, after the cleaning process is completed, a dehydrogenation peroxide process is not necessary. As a result, it is easy to treat wastewater, and it will not cost a great deal to treat the wastewater.

Second, since the cleaning process is performed at a room or low temperature, the evaporation of ammonium hydroxide and the decomposition of ozone can be inhibited compared to a cleaning process performed at a high temperature. Thus, contaminant removal efficiency on the wafer surface is maximized, the lifetime of the cleaning solution is prolonged, and the consumption of chemical usage can be reduced.

Third, since a cleaning process is performed at a low temperature, an extra thermostat such as a heater or a temperature sensor is not required in the semiconductor cleaning apparatus. Thus, the semiconductor cleaning apparatus is downsized and lightweight.

As described above, according to the present invention, a mixed chemical solution composed of aqueous ammonium hydroxide and ozone is used for wafer cleaning process as a cleaning solution. Thus, it is easy to treat wastewater, the consumption of chemical usage is considerably reduced, and contaminant removal efficiency on the wafer surface is maximized at a room or low temperature. As a result, the semiconductor cleaning apparatus is downsized and lightweight.

What is claimed is:

1. A semiconductor cleaning apparatus comprising:
a cleaning bath supplied with a cleaning solution composed of ammonium hydroxide, deionized water and ozone;
a megasonic transducer for applying uniform megasonic power to the cleaning bath using water as a medium;
an ozone concentration analyzer for measuring the concentration of ozone in the cleaning solution;
pH and Eh meters for measuring the pH and Eh of the cleaning solution;
an ammonium hydroxide addition injection port for additionally supplying ammonium hydroxide into the cleaning bath if the concentration of ammonium hydroxide in the cleaning solution decreases to less than a predetermined amount;
a mixing tank for mixing ammonium hydroxide, deionized water and ozone in a predetermined volume ratio;
a first filter for removing ozone bubble components in the cleaning solution supplied from the mixing tank;
a supply pipe for supplying the cleaning solution into the cleaning bath through the first filter;
an ammonium hydroxide tank for supplying ammonium hydroxide into the mixing tank;
an ozone generator connected to the mixing tank and the cleaning bath, the ozone generator for supplying ozone into the mixing tank early on a cleaning process and supplying ozone into the cleaning bath after the supply of the cleaning solution into the cleaning bath is exhausted;
a circulation pump for circulating the cleaning solution in the cleaning bath through the;
a chiller for lowering the temperature of the cleaning solution circulated through the circulation pipe to a low temperature;
a second filter for removing particle components of the cleaning solution supplied through the circulation pipe; and
a wastewater discharging pipe for discharging the almost exhausted cleaning solution.

2. The semiconductor cleaning apparatus of claim 1, wherein the chiller stops driving if the cleaning process is performed at a room temperature and drives only if the cleaning process is performed at a low temperature.

3. A method of cleaning a wafer surface comprising:
forming a cleaning solution by adding ozone to aqueous ammonium hydroxide, which is composed of ammonium hydroxide and deionized water in the volume ratio of 0.001-0.01:5;
supplying the cleaning solution into a cleaning bath through a filter for removing ozone bubble;
applying megasonic power to the cleaning solution in the cleaning bath using a megasonic transducer; and
dipping a wafer surface in the cleaning solution which is at a room temperature to remove contaminants on the wafer surface.

4. A method of cleaning a wafer surface comprising:
forming a cleaning solution by adding ozone to aqueous ammonium hydroxide, which is composed of ammonium hydroxide and deionized water in the volume ratio of 0.001-0.01:5;
supplying the cleaning solution into a cleaning bath through a filter for removing ozone bubble;
circulating the cleaning solution in the cleaning bath through a circulation pipe and then supplying the cleaning solution into the cleaning bath again along the circulation pipe through a chiller;
applying megasonic power to the cleaning solution in the cleaning bath using a megasonic transducer; and
dipping a wafer surface in the cleaning solution which is at a low temperature of 10-15° C. to remove contaminants on the wafer surface.
